(19) United States
(12) Patent Application Publication
(10) Pub. No.: US 2009/0112705 A1
(43) Pub. Date: Apr. 30, 2009

(54) SYSTEM AND METHOD FOR PROXY VOTING BY INDIVIDUAL INVESTORS

(76) Inventors: Lawrence S. Eiben, Richmond, VA (US); Eric S. Newman, West Chester, PA (US)

Correspondence Address: MCGUIREWOODS, LLP, 1750 TYSONS BLVD, SUITE 1800, MCLEAN, VA, 22102, US

(21) Appl. No.: 12/257,560

(22) Filed: Oct. 24, 2008

Related U.S. Application Data
(60) Provisional application No. 60/982,350, filed on Oct. 24, 2007.

(51) Int. Cl. G07C 13/00

(52) U.S. Cl. 705/12

(57) ABSTRACT

A system and method for an electronic public forum to facilitate solicitation support of shareholder initiatives (e.g., for inclusion on an annual ballot or for a special vote, for instance). The public forum may be a web site provided as a service that permits individual stakeholders to view positions of third party entities such as activist non-profits, corporation, and individuals associated with issues related to a company's annual shareholder ballots, for example. Third parties may post general information regarding corporate issues and/or sample ballots on the web site with rationale for their positions. An individual stakeholder may use the proffered sample ballot during voting of their shares. In this way, individuals may align their votes with a particular cause of a third party. Moreover, real time results of any voting may be displayed.

### CROSS-REFERENCE TO RELATED APPLICATIONS

This application claims priority under 35 U.S.C. §119(e) to provisional U.S. Patent Application No. 60/982,350, filed on Oct. 24, 2007, entitled “PROXY VOTING BY INDIVIDUAL INVESTORS,” the disclosure of which is incorporated by reference herein in its entirety.

### BACKGROUND OF THE INVENTION

1. Field of the Invention

The invention is directed generally to a method and system that facilitates proxy voting by electronic ballot and, more particularly, to a method and system that includes facilitating proxy voting by electronic ballot to permit investors to efficiently cast proxy votes electronically, which correspond to the votes of various third-parties that have posted sample ballots to the system.

2. Related Art

Publicly traded companies (or corporations) are required to hold annual meetings. The companies may also hold interim meetings as needed. The annual meetings typically serve to acquire shareholder and/or bond holder approval on proposals related to the company's affairs, operations, management, or the like. Moreover, the company may hold other meetings and/or consent solicitations whenever shareholder or bondholder approval is necessary, such as for takeovers, buyouts, or the like. Typically, the routine to conduct such proceedings may include: setting a date; submitting filings for the meeting; receiving and tabulating shareholders' votes for shareholders or bond holders such as individuals, companies, groups, etc. In many situations, a separate company may be hired to facilitate the overall process.

Currently, if a company, a dissident shareholder, or another third-party wishes to affect the voting results for an annual meeting, for example, agents are often hired to contact shareholders or bond holders to deliver a message for solicitation purposes. The agent may be known as a “Solicitor.” Often, the Solicitor contacts shareholders or bond holders by mail or telephone. Sometimes public media is used if a large shareholder/bondholder base is at issue. These initiatives could be expensive (e.g., full page ads in a national paper) and inexact.

Those wishing to undertake an initiative for a shareholder vote often face a battle with the company management in which neither side clearly knows their level of support until all proxy votes are tabulated and released. Substantial resources may be required to garner support for an issue and for the legal maneuverings to submit the issue for a vote.

However, an unfulfilled need exists for enabling individual investors to, without charge, vote proxy ballots electronically while simultaneously providing access to voting guidance in the form of intended votes and voting rationale of an unlimited number of independent third-parties. Moreover, a further need exists for individuals holding a relatively small number of shares to band together and quantifies support from others in support of their positions in order for the company's management to place credibility in the shareholder argument. Moreover, a further need exists for stakeholders to participate in forums which are limited to similarly verified stakeholders (i.e. shareholders, bondholders, company employees, mutual fund shareholders, etc.). Moreover, a further need exists to permit individual investors to efficiently populate their own ballots with the suggested votes of the third-party of their choosing.

### SUMMARY OF THE INVENTION

The invention meets the foregoing needs and provides a method and system that facilitates proxy voting by electronic ballot and that furthermore includes other advantages apparent from the discussion herein.

In one aspect, a method for electronically casting proxy votes via an on-line system is provided that includes presenting a prompt to select a company, validating that a user of the on-line system is a stakeholder in the selected company, displaying at least one pre-filled out proxy ballot provided by a third party, the third party being other than the selected company or an agent of the company and receiving a selection to cast at least one vote based at least in part on the displayed pre-filled out ballot.

In another aspect of the invention, a system for electronically casting proxy votes is provided that includes a web site configured to provide information related to at least one voting issue related to at least one company, a first computer based component configured to execute and electronically display a voting summary, the voting summary including information related to at least one company and information related to a position of a third party, the third party being other than the at least one company and a user receiving the displayed voting summary, and a second computer based component configured to execute and to electronically receive a response to a displayed pre-filled ballot related to the third party position for the at least one company, wherein a voting total is displayed on the web site for the at least one voting issue.

In another aspect of the invention, a system to publish corporate voting information on-line is provided that includes a first computer based subsystem configured to receive a third party compiled ballot along with rationale position information, a second computer based subsystem configured to present the third party ballot and rationale information to at least one stakeholder and a third computer based subsystem to tabulate a total vote registered by all on-line voting shareholders for display on-line.

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the invention, are incorporated in and constitute a part of this specification, illustrate embodiments of the invention and together with the detailed description serve to explain the principles of the invention. No attempt is made to show structural details of the invention in more detail than may be necessary for a fundamental understanding of the invention and the various ways in which it may be practiced. In the drawings:

FIG. 1 is an exemplary block diagram of a system configured according to principles of the invention;

FIG. 2 shows an exemplary website page of a meeting list and vote summary according to an aspect of the invention;

FIG. 3 shows an exemplary website page of a tool to facilitate voting according to an aspect of the invention;

FIG. 4 shows an exemplary website page of a list of public postings for a given meeting according to an aspect of the invention; and

FIG. 5 shows an exemplary website page of votes and rationale from a specific third-party according to an aspect of the invention;

FIG. 6 is a flow diagram showing an exemplary process for using a system configured according to principles of the invention, the process performed according to principles of the invention;

FIG. 7 is an exemplary flow diagram for accessing the public forum, the steps performed according to principles of the invention;

FIG. 8 is a flow diagram showing exemplary process for a user login, the steps performed according to principles of the invention;

FIG. 9 is an exemplary flow diagram showing a process for capturing a vote, the steps performed according to principles of the invention;

FIG. 10 is an exemplary flow diagram of a process for updating a vote tally, the steps performed according to principles of the invention; and

FIG. 11 is an exemplary flow diagram of a process for using the system configured according to principles of the invention, the steps performed according to principles of the invention

### DETAILED DESCRIPTION OF THE INVENTION

It is understood that the invention is not limited to the particular methodology, protocols, etc., described herein, as these may vary as the skilled artisan may recognize. It is also to be understood that the terminology used herein is used for the purpose of describing particular embodiments only, and is not intended to limit the scope of the invention. It is also to be noted that as used herein and in the appended claims, the singular forms “a,” “an,” and “the” include the plural reference unless the context clearly dictates otherwise. Thus, for example, a reference to “an address” is a reference to one or more addresses and equivalents thereof known to those skilled in the art.

Unless defined otherwise, all technical and scientific terms used herein have the same meanings as commonly understood by one of ordinary skill in the art to which the invention pertains. The embodiments of the invention and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the invention. The examples used herein are intended merely to facilitate an understanding of ways in which the invention may be practiced and to further enable those of skill in the art to practice the embodiments of the invention. Accordingly, the examples and embodiments herein should not be construed as limiting the scope of the invention, which is defined solely by the appended claims and applicable law. Moreover, it is noted that like reference numerals reference similar parts throughout the several views of the drawings.

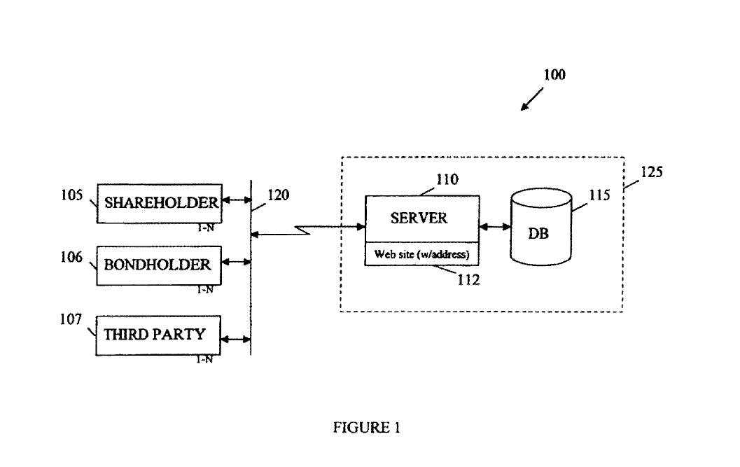

FIG. 1 is an exemplary block diagram of a system configured according to principles of the invention, generally designated by reference numeral 100. The system 100, which may include a computer platform, includes one or more shareholder access devices 105, one or more bondholder access devices 106 and one or more third party access devices 107. These access devices 105, 106, 107 may be a personal computer, a handheld communications device, or the like, that may be in communication with a server 110 over a network 120, such as the Internet. The server 110 may have access to a database 115 configured to maintain shareholder, bondholder, third party information and/or corporate related information for supporting the functionality of the system, as described more fully below.

In certain aspects provided by the invention, a public forum may be provided to facilitate solicitation support of shareholder initiatives (e.g., for inclusion on an annual ballot or for a special vote). The public forum may be embodied in a computerized system such as system 100 and managed by an entity, logically illustrated by reference numeral 125. The entity 125 may be a company, for example, that may provide a service that includes maintaining at least some of the functional features associated with the system of FIG. 1, and described more fully below.

According to an aspect of the invention, the entity 125 may maintain a web site 112 having a network or web address for displaying and managing the public forum for facilitating proxy voting by individual investors (e.g., shareholders and/or bondholders), and other features. In FIG. 1, the server 110 is shown as providing and supporting the web site 112, although other architectures and configurations are possible as would be known by those skilled in the art. Typically, individual investors may use the service free of charge.

Entity 125 may act as a conduit to a proxy voting process while exercising no decision control over the casting of votes, during a voting period. A nearly unlimited number of independent third-parties 107 may be permitted to post their intended votes and voting rationale on the web site 112. The voting information and voting rationale may be maintained in the database 115. Shareholders and/or bondholders casting votes through the web site 112 may elect to vote in the same way as the third-parties 107, as described more fully below.

The entity 125 may be compensated for providing its service in, e.g., two ways. First, the entity 125 may be compensated through advertising fees that may be paid by companies choosing to advertise products and services on the web site 112. Some of these companies may be soliciting proxy votes. Second, listing fees may be paid by the independent third-parties 107 to display their votes/voting rationale and to enable certain linking functionality with the site's voting tool.

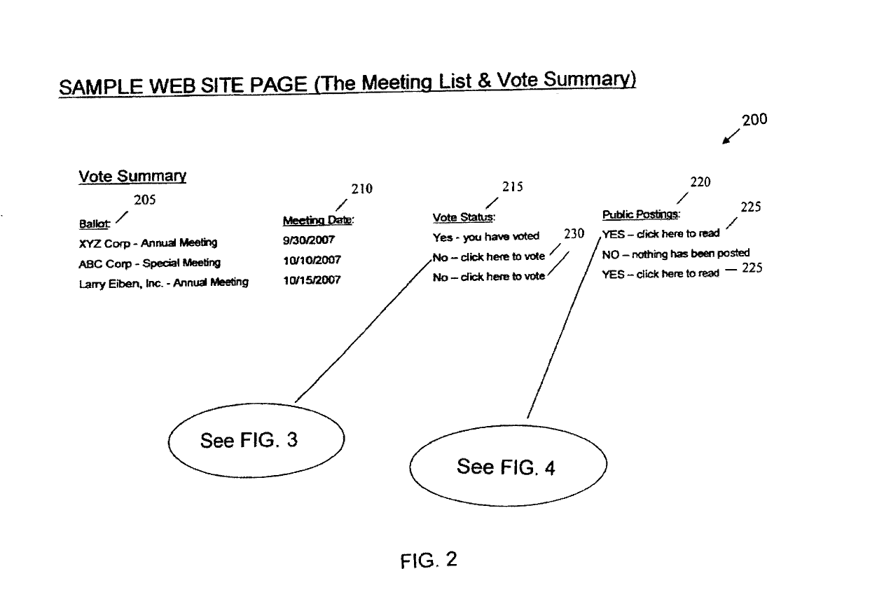

As noted earlier, according to an aspect of the invention, the entity 125 may create and manage the web site 112 that may include the necessary software, middleware and/or hardware, as the skilled artisan will readily recognize, to carry out various functions including providing the web site pages (as shown, for example, in FIGS. 2 through 5) to individual stake-holders, including investors.

The public forum, such as that provided by the web site 112, may unite investors who collectively hold relatively large portions of companies, for example, although smaller investors may also benefit. The web site 112 may improve the current manual process of voting and empower investors to communicate with management and make their voice heard. The web site 112 may also provide an opportunity for investors to discuss and debate issues with other shareholders.

Currently, proxy voting services that provide advice to institutional investors generally do not provide advice for individuals. An estimate of individual investors having brokerage accounts may be about 10-15 million (in the U.S.), but there is no easy way to gather information and/or vote their shares in support of opinions other than those put forth by company management. Individual investors typically must wade through weighty, often baffling, proxies on their own to determine any issues at hand. However, the proxy voting service provided by the web site 112 permits collaboration between such investors, and permits third party organizations to present their positions on pending issues to the individual investors. In support of this, a message board (perhaps configured to support text, audio, video, in any combination) serve may be provided for verified stakeholders. The third party organizations may include, for example, activist non-profit organizations (such as an animal rights group, an environmental advocacy group, a trade union, or the like), activist hedge funds or institutions, individuals, an individual account holder, corporations, or the like. Verified stakeholders may include shareholders, bondholders, company employees, mutual fund shareholders, or individuals/entities verified as able to gain access to the online system or selected protected portions thereof.

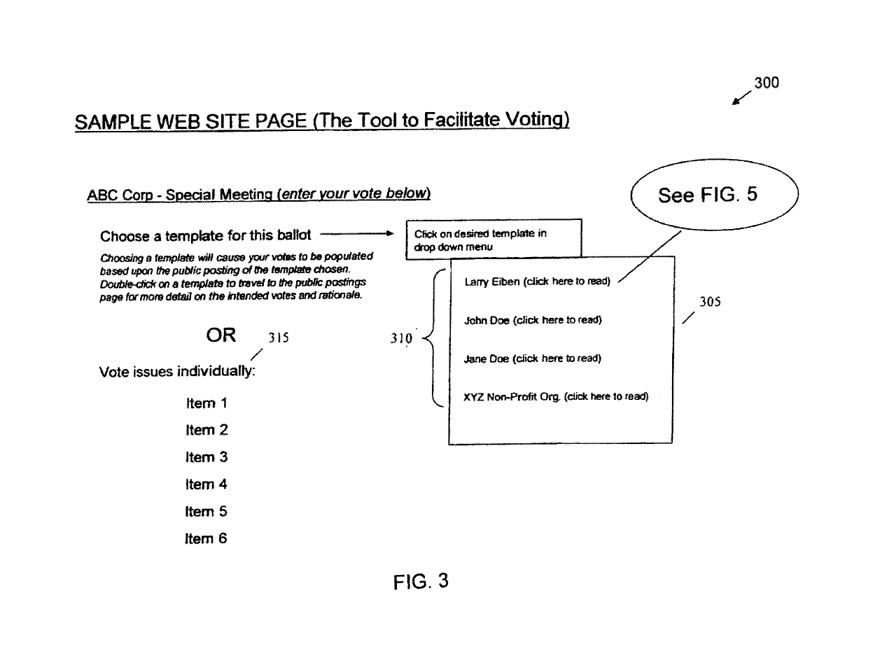

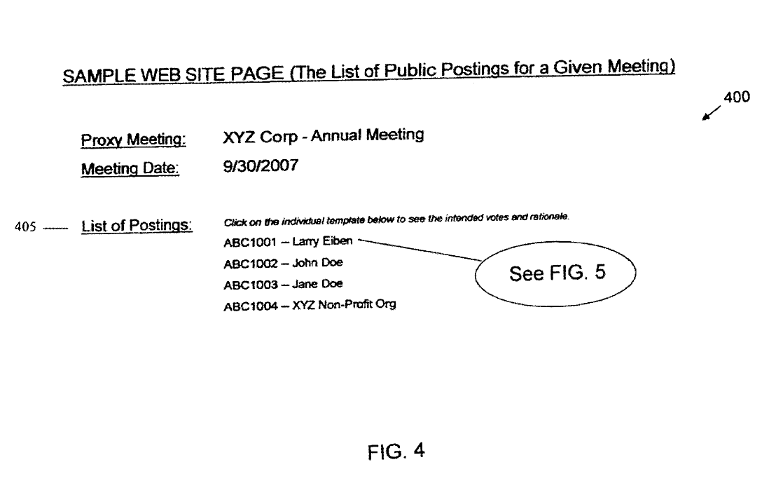

FIG. 2 shows an exemplary website page of a meeting list and vote summary according to an aspect of the invention, generally designated as reference numeral 200. The web (or website) page 200 may also represent a corresponding software component embodied in a computer platform for generating and receiving input from the web page 200. The web page 200 shows a vote summary for various corporations indicating the type of ballot 205 for each listed corporation, meeting date 210, the status of the individual's vote status 215 for each listed ballot 205, and whether there are any public postings 220 related to the respective ballot. If there are any public postings 220 (indicated by “Yes”), the public postings may be accessed by, e.g., clicking on, or selecting the respective link 225. A vote status link 230 may also be selected in order to vote on a ballot. By selecting the vote status link 230, a new web page 112 may be presented to the user for prompting for one or more votes, as shown in reference to FIG. 3. Similarly, public postings may be accessed by selecting link 225, where a new web page 112 may be presented to the user, as shown in reference to FIG. 4.

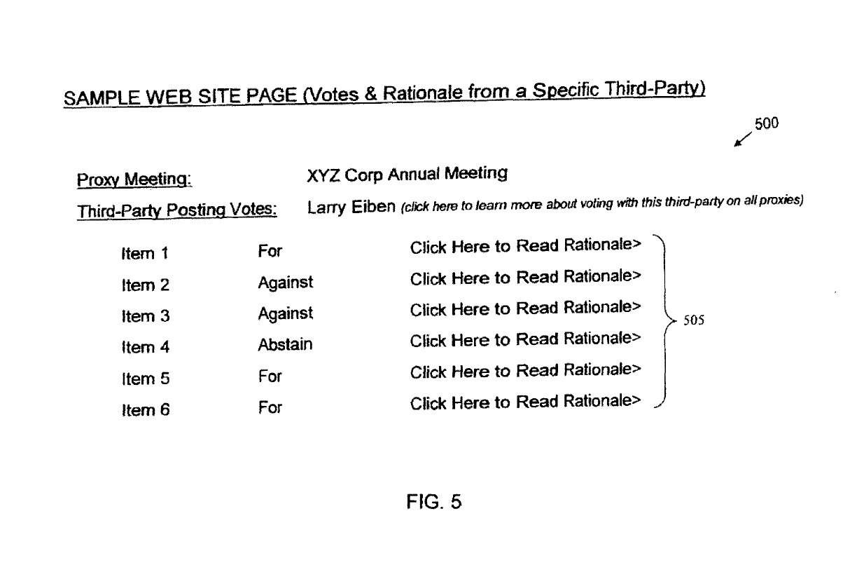

FIG. 3 shows an exemplary website page of a tool to facilitate voting according to an aspect of the invention, generally designated as reference numeral 300. The website page 300 may also represent a corresponding software component embodied in a computer platform for generating and receiving input from the website page 300. The website page 300 may include a menu 305 for viewing and/or selecting from the prompts presented for choosing a template for voting. The templates presented in the menu 305 provide a basis for populating an individual user's ballot with predefined positions associated with each template. Moreover, each template may be viewed by clicking on one of the links 310 associated with each template, and as shown in reference to FIG. 5. Alternatively, an individual user may choose to vote on each issue individually, represented by items 1-6, generally designated as reference numeral 315.

FIG. 4 shows an exemplary website page of a list of public postings for a given meeting according to an aspect of the invention, generally designated by reference numeral 400. The website page 400 may also represent a corresponding software component embodied in a computer platform for generating and receiving input from the website page 400. The list of postings 405 may include multiple postings; each posting may be selected (e.g., by clicking on the link) for reading the template and/or rationale for the respective posting, as shown in reference to FIG. 5. The website page 400 may include a mechanism for searching and/or sorting the postings. Sorting may be performed base on paid placement, user preferences, date/time, or other sort criteria.

FIG. 5 shows an exemplary website page of rationale from a specific third-party according to an aspect of the invention, generally designated as reference numeral 500. A user may access for a respective company (in this example, XYZ Corp), one or more respective rationales 505, for respective items 1-6, from a third party (e.g., posted by Larry Eiben). The position (such as, e.g., for or against) taken by the third party may also be viewed.

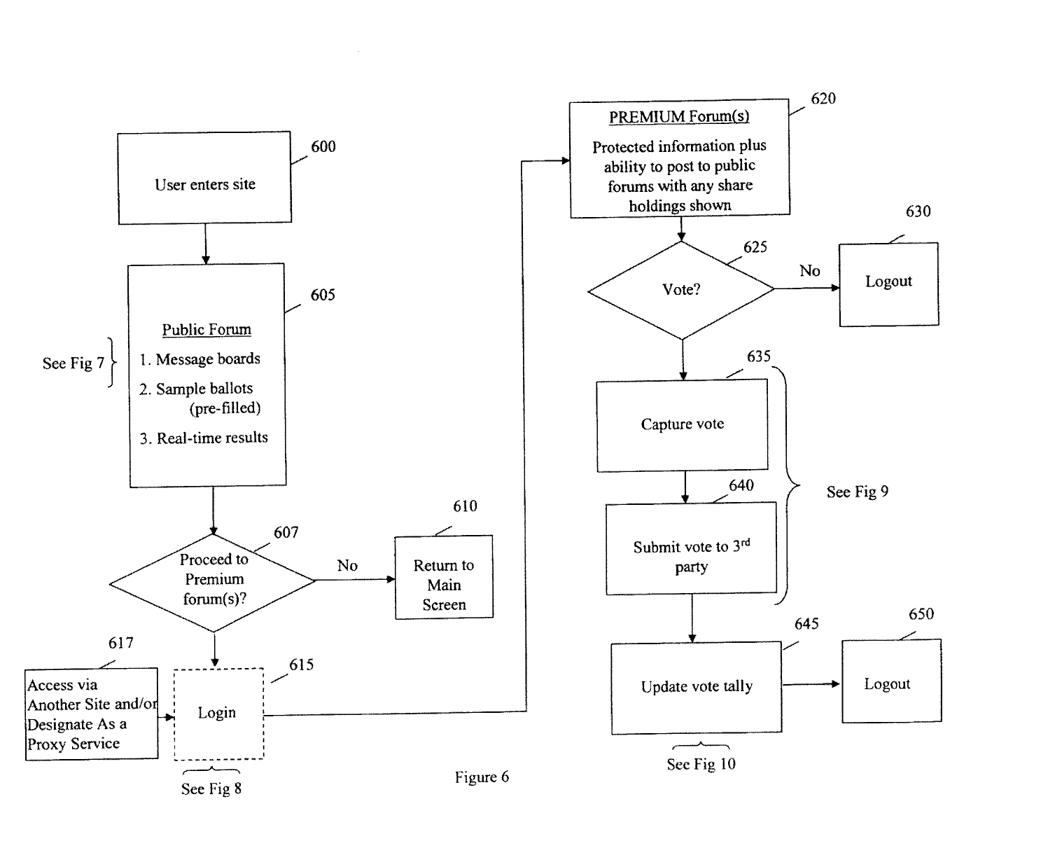

FIG. 6 is a flow diagram showing an exemplary process for using a system configured according to principles of the invention, the process performed according to principles of the invention. FIGS. 6-11 may equally represent a high-level block diagram of components of the invention implementing the steps thereof. The steps of FIGS. 6-11 and any other flow diagrams herein may be implemented on computer program code in combination with the appropriate hardware for execution thereon. This computer program code may be stored on storage media such as a diskette, hard disk, CD-ROM, DVD-ROM or tape, as well as a memory storage device or collection of memory storage devices such as read-only memory (ROM) or random access memory (RAM). Additionally, the computer program code can be transferred to a workstation over the Internet or some other type of network, perhaps using client-server architectures and the like. The processes or portions thereof described herein may be provided by one or more computer based sub-systems.

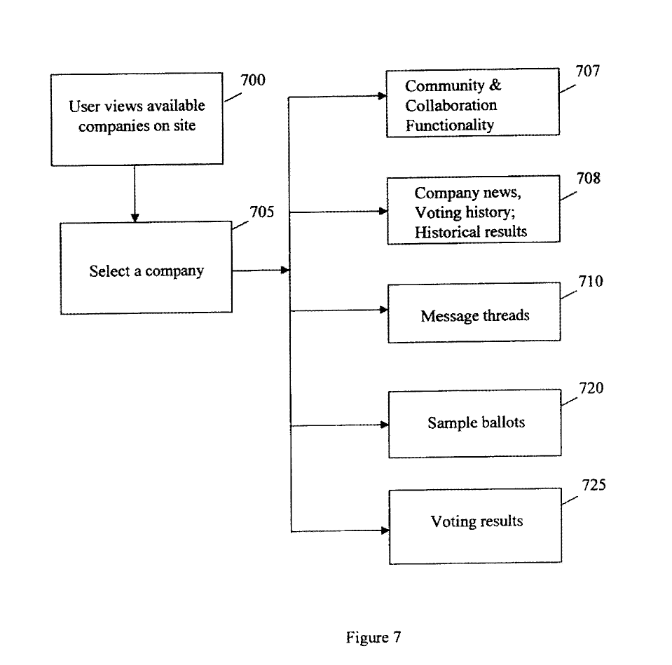

Referring to FIG. 6, at step 600, a user (e.g., shareholder, bondholder, or the like) may enter the web site 112. The user may have been previously established an account, perhaps with security parameters with the web site 112. At step 605, the user may access and/or view the public forum portion(s) of the web site 112 (described more fully in relation to the steps of FIG. 7). At step 607, a check may be made to see if the user has requested to enter a premium forum (which may be in response to a prompt presented by the web site). If not, then processing may continue at step 610 with other processing (such as, e.g., returning to a main screen or remain in the public forum).

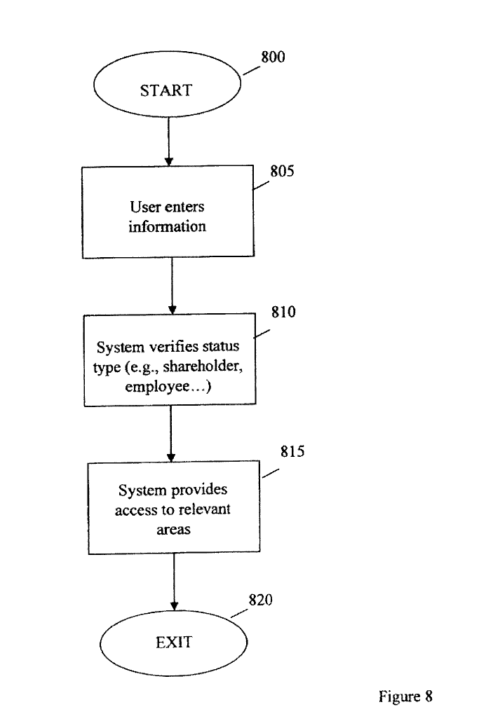

If, however, the user has indicated to enter the premium forum, at step 615, a login process may be initiated wherein the user identifies himself or herself, perhaps with a password, and may be authenticated as being a valid user, stakeholder type, and/or current shareholder, described more fully in relation to FIG. 8. Step 615 may be also entered from an alternate path shown as step 617, which represents access via another web site such as a web site of a financial or a brokerage institution, where a user stakeholder may have an existing account. The user stakeholder may also indicate to the financial or brokerage institution that the service provided by the invention should serve as a proxy service for voting on behalf of the user stakeholder, perhaps itemized by specific company for proxy voting purposes. When entering from step 617, the login step 615 may be automated, or even by-passed, if a secure hand-off occurs so that acceptable verification of the user is achieved. At step 620, stakeholder information may be viewed and/or accessed. Additionally, the user may post information to a public forum, possibly with share holdings shown (e.g., the voting basis).

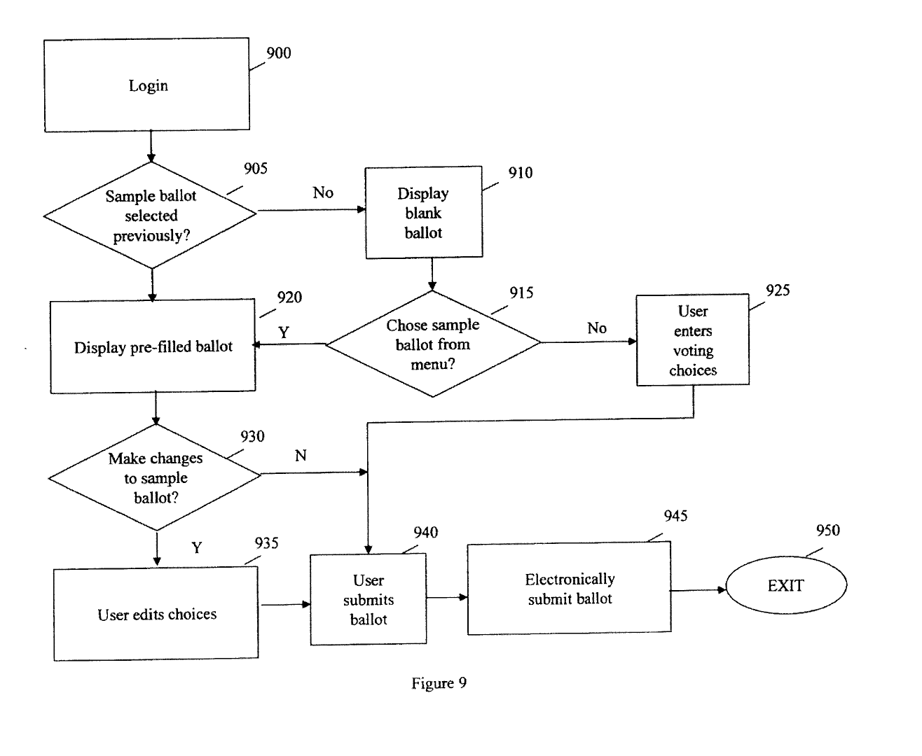

At step 625, a check may be made whether or not the user wishes to vote on a ballot or issue (which may be in response to a prompt, for example). If not, at step 635, the user may logout. If however, the user indicates that he/she wants to vote, at step 635, the vote may be captured. This step 635 is described more fully in relation to FIG. 9, where more sub-steps are described. At step 640, the vote may be submitted to a third party, perhaps a proxy service and/or a company associated with the vote. At step 645, a vote tally may be updated, perhaps for display in the public forum such as at step 605. At step 650, the user may logout.

FIG. 7 is an exemplary flow diagram for accessing the public forum(s), the steps performed according to principles of the invention. At step 700, a user may view one or more available companies on the site. The display of the one or more companies may be restricted to the user's verified shareholding or stakeholder rights. At step 705, the user may respond to a prompt for selection of a company. At step 710, the user may choose to view message threads (on a message board, for example) related to the selected company. In some embodiments, the user may be verified as a stakeholder to access the message threads. Moreover, in some implementations, premium forum messages may be copied to the public forum (see, step 605, for example) message board and/or threads. At step 720, the user may choose to view one or more sample ballots. In some embodiments, the one or more sample ballots may be displayed based on respective one or more third party recommendations. At step 725, the user may view voting results, which may include current totals, for any issue for the selected company.

FIG. 8 is an exemplary flow diagram showing an exemplary process for a user login, the steps performed according to principles of the invention, starting at step 800. At step 805, the user may enter one or more of: a password, an account number, a control number from a proxy ballot, one or more stock certificate numbers, document numbers, or other identifying information. A user may also access the site via a third-party partner site (i.e. a brokerage account) which could automatically verify their status and identity for access to this system. At step 810, the system may verify holdings to confirm current status type. A current status type may include one of: shareholder, a specific activist group, an employee of the company, a mutual fund shareholder, or the like. At step 815, access to premium, or permitted areas based on status type, of the system may be granted. At step 820, the process may exit.

FIG. 9 is an exemplary flow diagram showing a process for capturing a vote, the steps performed according to principles of the invention, starting at step 900. At step 900, a login may be performed, which may involve the login process as described in relation to FIG. 8, if not already performed. At step 905, a check may be made whether or not a ballot has been previously selected. A previously selected ballot may include use of auto preferences, as previously defined for the logged-in user. For example, an auto preference might stipulate that a ballot be pre-selected and populated for voting based on the recommendations of a specific third party (perhaps an animal rights group, for example). The specific third party may have previously provided a template ballot or position recommendation. If so, the processing may continue with step 920. If not, at step 910, a blank ballot may be displayed.

At step 915, a check is made whether or not the user has made a selection of a sample ballot from a menu or list, for example. If not, at step 925, the user may enter voting choices. The process may continue at step 940. However, if at step 915 it has been determined that a sample ballot has been chosen, at step 920, a pre-filled ballot may be displayed. At step 930, a check may be made to determine if the user wishes to make changes to the sample ballot. If yes, then at step 935, the user may edit the ballot and processing may continue at step 940. If not at step 930, then, at step 940, the user may submit the ballot. At step 945, the ballot may be electronically submitted, perhaps to a proxy voting service and/or the company (e.g., a Broadridge service), at any time before any voting period ends. In some implementations, the ballot may be revised anytime before the electronic submission and before the voting period ends. At step 950, the process may exit.

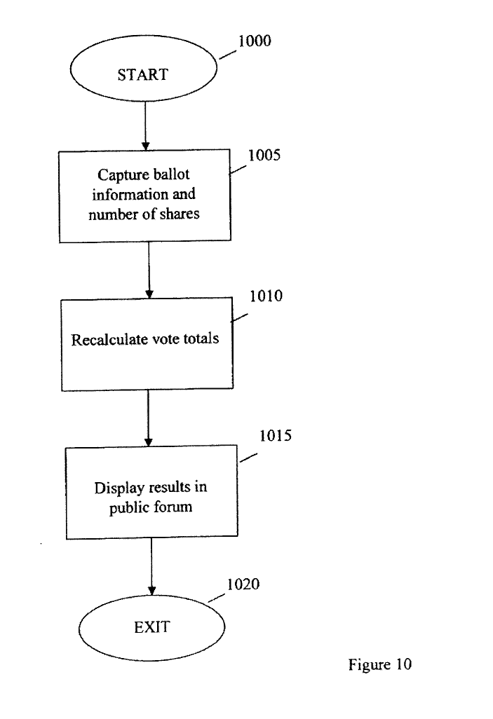

FIG. 10 is an exemplary flow diagram of a process for updating a vote tally, the steps performed according to principles of the invention, starting at step 1000. At step 1005, ballot information may be captured, along with the number of shares applicable for user. At step 1010, vote totals for the ballot and issues for the company involved may be recalculated. At step 1015, results may be displayed to the user and/or in the public forum. At step 1020, the process may end.

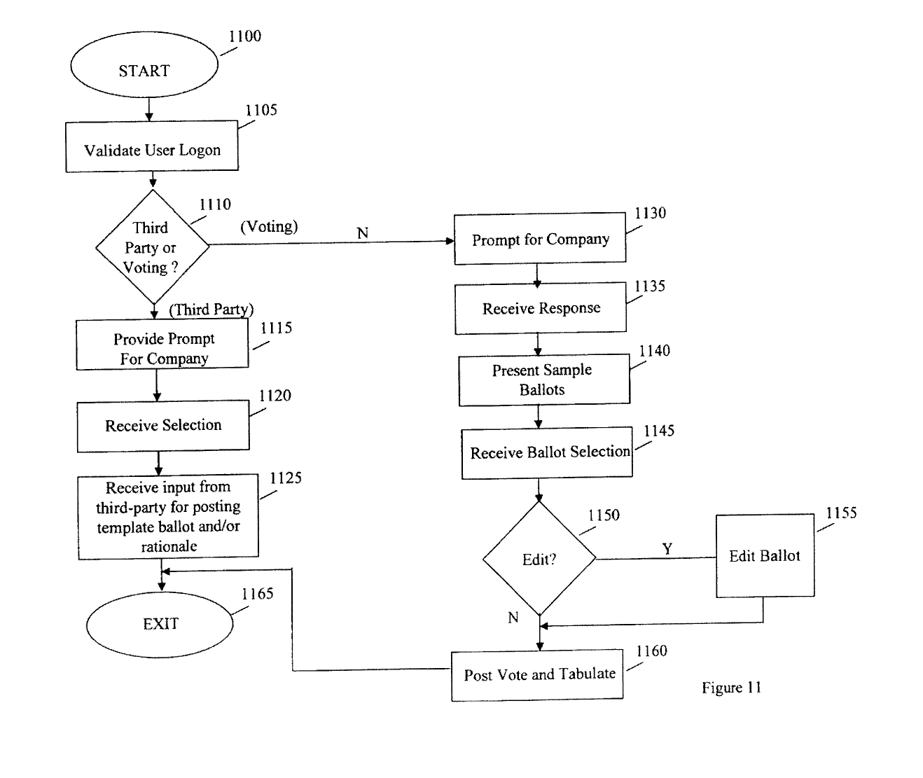

FIG. 11 is an exemplary flow diagram of a process for using the system configured according to principles of the invention, the steps performed according to principles of the invention, starting at step 1100. At step 1105, a user may be validated for access to the system. The validation may include checking a password, an account record, and/or current status as a stakeholder. At step 1110, a check may be made to determine if the user is a third party. If yes, at step 1115, a prompt may be issued for the user to select a company. At step 1120, a response may be received selecting a company. At step 1125, an input related to the selected company may be received from the third party. The input may include information related to the company, rationale related to items for a vote, and/or a template ballot with pre-designated positions (i.e., with proposed voting positions), perhaps reflecting the rationale. In this way, a sample ballot may be created for eventual presentation as a template for proxy voting. The third party information may be maintained in a database (e.g., database 115 in FIG. 1) for future use. The process may exit at step 1165.

If however, at step 1110, the user is not a third party, rather a voting stakeholder such as, e.g., a shareholder or bondholder, then at step 1130 a prompt may be issued for selecting a company from one or more companies that the voting stakeholder may have positions. At step 1135, a response may be received indicating a selection. At step 1140, one or more sample ballots (with or without links to public posting and/or rationale positions) may be presented for consideration by the voting stakeholder. At step 1145, a response may be received indicating a ballot selection, or a selection of a link to postings or rationale. At step 1150, a check may be made whether or not the voting stakeholder wishes to edit a vote on a ballot. If yes, the voting stakeholder may edit the ballot at step 1155 and the processing may continue at step 1160. However, if the voting stakeholder does not with to edit the vote on the ballot at step 1150, then, at step 1160, a ballot may be cast and tabulated. A voting total may be computed, the total may be cumulative for all votes from all voters. At step 1165, the process may end.

Users of this online service may present an issue to other shareholders or stakeholders for their support through the public forums (perhaps to “avoid” and/or comply with solicitation regulations) and get a sense for the amount of support they may have via the site's stakeholder verification step. This provides the champion of an initiative hard evidence of the percentage of shareholders in support of their initiative. This may be an important factor in certain circumstances in convincing a corporation to include an initiative on its ballot, especially in the case of initiatives that challenge the status quo. The online system described herein may or may not lessen the legal expenses for an individual issue, but it may give the issue's sponsor a heightened level of certainty to enter that phase.

Fees may be collected based on advertising on the web site. Third parties or other corporations may be motivated to place relevant ads related to positions, products or other services, or the like. Moreover, fees may be charged for access to one or more aspects of the web service.

In some implementations, an investor may request or stipulate that a current brokerage house or financial institution, where the investor may have an account with holdings, is to use the service provided by the invention for proxy voting. In this way, an institutional investor or individual investor may participate more actively in the voting process, perhaps by entering the message boards or employing other features of the provided service.

TABLE I is an example for “Terms of Use” involving an Entity that provides web site services for facilitating proxy voting, a public forum, or the like:

TABLE I
I agree that “Entity”, the owner and operator of Entityvoice.com, is in no way soliciting my
proxy vote and has no control whatsoever over how my votes are cast.
I understand that “Entity's” intent in creating this web site is to provide a public forum for
the dissemination proxy voting information and to assist individual investors in more
efficiently casting their proxy votes.
I understand that “Entity” is not affiliated with any of the individuals or companies posting
their intended votes and voting rationale on this site and has no desire to influence specific
votes. “Entity” is compensated through advertisements and by companies choosing to post
votes so its only desire is to increase usage of the site.
I understand that “Entity” does not, in any way, endorse any of the individuals or
companies posting their votes on this site and “Entity” does not have the authority to edit
votes and voting rationales. “Entity” does not prohibit any firm or individual from posting on
this site and all paying clients are subject to an identical fee schedule to ensure fair and
equal treatment.
I understand that “Entity” is under no obligation to ensure that individuals posting on this
site are in compliance with the proxy provisions of the Securities Exchange Act of 1934. It
is the obligation of each individual and company posting votes and voting rationales to
comply with the federal securities regulations.
I understand that “Entity” receives compensation from public companies for the product
and service advertisements shown on this site. I realize that certain companies may
advertise on this site that also have ballots voted through this site and “Entity” is under no
obligation to prevent this situation. “Entity” doesn't require or accept advertisements
conditioned on the posting of intended votes or voting rationale.

While the disclosure has been described in terms of exemplary embodiments, those skilled in the art will recognize that the disclosure can be practiced with modifications in the spirit and scope of the disclosure. These examples given above are merely illustrative and are not meant to be an exhaustive list of all possible designs, embodiments, applications or modifications of the disclosure.

We claim:

1. A method for electronically casting proxy votes via an on-line system, the method comprising the steps of:
presenting a prompt to select a company;
validating that a user of the on-line system is a stakeholder in the selected company;
displaying at least one pre-filled out proxy ballot provided by a third party, the third party being other than the selected company or an agent of the company; and
receiving a selection to cast at least one vote based at least in part on the displayed pre-filled out ballot.

2. The method of claim 1, further comprising:
submitting the vote to a third party for processing.

3. The method of claim 1, further comprising:
tallying the at least one vote to generate a total vote; and
displaying the total vote in an electronic public forum.

4. The method of claim 1, wherein displaying the at least one pre-filled out ballot includes displaying information related to a third party position related to the pre-filled out ballot.

5. The method of claim 1, further comprising displaying a vote status that indicates that a user of the on-line system has already voted.

6. The method of claim 1, further comprising:
displaying rationale information posted by the third party related to recommended votes for a selected company.

7. The method of claim 1, further comprising:
receiving an input to edit the pre-filled out ballot to change at least one vote on the ballot.

8. The method of claim 1, further comprising:
charging a fee to the third party.

9. The method of claim 8, wherein charging the fee is based on adverting by the third party on the on-line system.

10. A system for electronically casting proxy votes, comprising:
a web site configured to provide information related to at least one voting issue related to at least one company;
a first computer based component configured to execute and electronically display a voting summary, the voting summary including information related to at least one company and information related to a position of a third party, the third party being other than the at least one company and a user receiving the displayed voting summary; and
a second computer based component configured to execute and to electronically receive a response to a displayed pre-filled ballot related to the third party position for the at least one company,
wherein a voting total is displayed on the web site for the at least one voting issue.

11. The system of claim 10, wherein the web site is further configured to present a public forum on the web site, the public forum including at least one of: a message board, a sample ballot and a real time voting result.

12. The system of claim 10, further comprising:
a verification component to verify a user of the web site is a current stakeholder.

13. The system of claim 10, further comprising:
a third computer based component configured to execute and receive rationale information related to the at least one voting issue from the third party for posting on the web site.

14. The system of claim 10, wherein the third party is any one of: a non-profit organization, a public company, a private company and an individual account holder.

15. The system of claim 10, wherein the second component is also configured to edit the pre-filled out ballot based on a user input.

16. The system of claim 10, wherein the voting total is cumulative of all votes from all on-line voters for the at least one company.

17. A system to publish corporate voting information on-line, comprising:
a first computer based subsystem configured to receive a third party compiled ballot along with rationale position information;
a second computer based subsystem configured to present the third party ballot and rationale information to at least one stakeholder; and
a third computer based subsystem to tabulate a total vote registered by all on-line voting shareholders for display on-line.

18. The system of claim 17, wherein the at least one stakeholder is validated as a current shareholder.

19. The system of claim 17, wherein the at least one stakeholder is validated as a current bondholder.

20. The system of claim 17, further comprising a fourth computer based subsystem for providing a message board to a verified at least one stakeholder.
